(19) United States
(12) Patent Application Publication
(10) Pub. No.: US 2011/0146124 A1
(43) Pub. Date: Jun. 23, 2011

(54) IDeal Garden Marker

(76) Inventors: Thomas S. Carlson, St. Paul, MN (US); Angelo Kusber, Savage, MN (US)

(21) Appl. No.: 12/973,077

(22) Filed: Dec. 20, 2010

Related U.S. Application Data
(60) Provisional application No. 61/288,759, filed on Dec. 21, 2009.

(51) Int. Cl. G09F 3/18; G09F 23/00

(52) U.S. Cl. 40/645

(57) ABSTRACT

A garden marker comprising a nameplate having a connecting portion with a tapered opening into which a stake may be inserted. The stake has fins adjacent the connection to the nameplate to make a secure and non-spinning connection. The stake has several bends which, when inserted into the earth, prevents the garden marker from spinning with wind.

### CROSS-REFERENCE TO RELATED APPLICATIONS

This is a utility application from U.S. Provisional Application Ser. No. 61/288,759 filed Dec. 21, 2010, the entire contents of which are incorporated herein by reference.

### STATEMENT REGARDING FEDERALLY SPONSORED RESEARCH OR DEVELOPMENT

Not Applicable.

### BACKGROUND OF THE INVENTION

This invention relates to a means of identifying plants garden marker and a rod for securing the marker to a raised position above the ground.

This invention is related to “garden markers” that are also often called plant identification markers or plant signs. Herein garden markers, garden signs, plant markers, plant identification markers and signs all mean the same thing. Although this invention would or could be used to plant identification, it can also be used for other applications, such as yard signs, garden plaques, election signs, etc. Thus, “garden markers” as used herein is not limited to use in a garden or to only identify plants.

This particular invention is made of two independent pieces, a stake and a name plate. Herein the word “stake” can be a metal or plastic rod. The nameplates can be made from multiple types of plastic or even metal.

For years, garden and plant identification markers have not met many of the needs of gardeners. In fact, on the internet and in garden magazines, many gardeners express their dissatisfaction with commercially available markers, or ask how they can create their own markers.

HostasDirect, Inc. parent company of IDeal Garden Markers, did a survey in January of 2008 in which over 430 gardeners responded. Over 66% were dissatisfied with their existing plant identification markers. To follow are some of the other results:
52% said they want to mark on the front and back of their garden markers.
38% said they were willing to pay 40 to 65 cents more to write on two sides.
The biggest problems gardeners face with their existing markers was the sun fading the writing or printed label imprinting on the name plate.
The second biggest problem is that the gardeners' markers fall apart meaning the nameplates can be easily removed from the stakes that the nameplates are supposed to be attached to.

This unique and new design solves the above problems and many others.
1) The present design is a break-through in garden markers. One of the reasons is because the garden marker allows for information to be printed on two sides of the name plate, because there are no wires, metal or plastic enclosures or supports, snap on devices, or anything else on the back side of the nameplate or supporting the nameplate which provides support for the writing or label surface, which blocks the gardener from the opportunity to write or see information on the back side of the nameplate:
The ability to add text on two sides of the name plates either via adhesive backed labels with printing or printing with pen or paint pens, etc., or adding via adhesive, double sided adhesive tape, foam or Velcro, additional nameplates to one or both side of the invention's nameplate instead of just one side, as is the case with most other garden markers, now means gardeners can write important information on their markers that they did not have space for previously without having a marker that was so large it ruined the natural look of the garden. My double-sided design doubles the amount of space available for information on the nameplate via hand writing or applying adhesives, adhesive tapes, double- sided tapes or double-sided foam adhesive tape adhered to additional nameplates, such as engraved metal or plastic nameplates. Thus, a gardener can reduce the size of the marker they need to accommodate the same amount of written information. The marker will then be less obtrusive due to its smaller size, but have the same capability of holding information, text, data or pictures herein called “information” as a marker twice as large.
The ability to add information on two sides also means that at least one side of the name plate will be exposed less to ultra violet light damaging sun. This benefit means that gardeners will be assured that their plants will be less likely to lose their information written on the “shady side” of the name plate as the plastic nameplate forms a protective barrier to the sun but the information can still be viewed by the gardener. Thus, the information on the back is in a sense “insurance” if the side facing the sun is destroyed by the U.V. sun.
Some gardeners want to be able to see the name of their plant's information on two sides, as an example when they walk around their gardens' they want to see the plant's information on the front and back, as is possible with our design.
2) The inventive design has the ability to securely attach a stake (of metal or plastic) to the desired name plate while also allowing for the gardener to separate the stake and name plate so that the nameplates and stakes are interchangeable. Many gardeners complain about their garden markers falling apart. Basically, the name plates can come off the stakes from contact with pets, deer, freezing and thawing snow or ice, gardeners' walking by and snagging them, rakes, hoes, garden hoses, and the like. I have designed a marker so that the tightness of the fit between the stake and the plastic name plate is adjustable based upon how far the gardener pushes the stake into the plastic tapered hole at the bottom of the nameplate as of course the further the rod is pushed into the tapered hole, the more resistance it will encounter and thus the tighter the fit will be. This allows the gardener to maximize the value of the expensive stakes or nameplates they purchase: There are many reasons they may desire to have interchangeable stakes and nameplates:
   a) as their plants change in the garden (through normal plant growth, changing their location in the garden, etc.) the nameplate's can be removed and thrown away or saved and new name plates with the new plant's names can be placed on the same stakes as the original name plates. Also, stakes can be changed to provide different stakes for the same nameplate and plant only the stake may have a shorter or longer length.
   b) allows gardeners to remove the nameplate from the stakes in the winter, when the nameplates might become unsightly when sticking above the snow and then attach the interchangeable stakes and nameplates together when they desire, as in the spring.
   c) This ability to remove the nameplate from the stake also can offer more efficient use of storage space and when shipping. This is because individual components will store more neatly and use less space themselves than when attached to the other component.

3) The inventive design is more attractive than most if not all others. The majority of garden markers on the market, when viewed from the front, have excess visible wires to hold the name plates to the stake, which are unsightly, can rust, or even reflect light creating an unattractive glint. Or, they have wires on the back of stake, which looks bad when viewed from the back or side. Of, they have large metal or plastic frames holding the one-sided nameplate to the supporting stake. My designs are very efficient. There are no wasted materials around the nameplates that can create an eye sore in the garden, which is what gardeners prefer next to their beautiful plants.
4) The design only requires one stake instead of two stakes like many in the market. This offers benefits such as: having less unsightly metal showing in the garden, one stake is easier to trim grass around than two stakes, one stake is less likely to trap debris than two stakes, and it is easier to push the stakes in the ground when there is one stake instead of two as in the case when you hit a rock.
5) The design does not require a third component, such as peg, screw or the like to hold the nameplate and stake together. My unique design allows a sufficient fit between the only two pieces, the plastic nameplate and a metal or plastic rod stake.
6) The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. §1.56(a) exists.

### BRIEF SUMMARY OF THE INVENTION

The invention provides an innovative means of creating a garden marker, plant identification product, garden plaque, or a general sign for other applications, from a separate specially fabricated metal or plastic rod and a specially fabricated plastic nameplate. They are designed in a new, innovative way that allows the two separate parts to be connected to each other quite securely without additional screws, plugs, etc., but still be removed from each other and thus the stakes and name plates can are interchangeable.

In addition, the stake's end that stays out of the soil that attaches to the nameplate via a specially designed tapered hole may also be bent to provide various angles for viewing based upon different gardener's preferences. These angles can vary but include a 90 degrees bend in the stake, a 45 degrees bend to the stake, and straight—no bend.

A portion of the rod's end that is inserted into the nameplate's tapered hole has the specially fabricated protruding metal portion on the side of the cylinder shaped rod (stake) that we herein call a fin(s). This protrusion extends out of the side of what before fabrication of the fin was a normally a round or oblong rod. When the rod with the fin is inserted inside the tapered hole the fin helps prevent the plastic nameplate (with the tapered hole) from spinning on the rod because it creates interference from allowing the rounder hole with slippery plastic to spin freely on the round or oval stake. The fin creates friction or an interference between the round rod and the tapered hole. The fin also serves as a means of stressing the plastic as it is inserted around the rod, so that the plastic stretches or tears, and the plastic creeps or flows around the protruding fin over time. The bottom of the stake that is inserted in the soil has a larger double bend that also prevents the stake from spinning in the soil. Although this particular double bend has been seen in at least one other garden marker design, the design in the garden marker innovation has large bends, to prevent the stake from spinning in the soil.

### BRIEF DESCRIPTION OF THE DRAWINGS

A detailed description of the invention is hereafter described with specific reference being made to the drawings in which:

FIG. 1 is a perspective view of a garden marker of the invention;

FIG. 2 is a partial assembly view of the garden marker of FIG. 1 showing the stake about to be inserted into the tapered opening of the name plate connecting portion;

FIG. 3 is an enlarged end view of a stake showing formed fins on the stake;

FIG. 4 is a partial view of the assembled garden marker with the stake and fins shown in phantom;

FIG. 5 is a cross-sectional view showing the name plate and connecting portion with a rod and its fins inserted therein;

FIG. 6 is a side view of a garden marker of the invention depicted inserted into the ground, with an arrow showing that the stake may be bent further so the nameplate is at a different angle; and

FIG. 7 is a partial view of a stake end for insertion into the ground showing an alternate spade end.

In all of the drawings above the following numbers designate certain features of the invention:

10—Shows the plastic nameplate which is often flat

12—Shows the connection portion where the rod with the protruding fins(s) are inserted into the tapered hole

14—Shows the fins which protrude from the otherwise round, cylinder shaped rod. These particular fins are flattened

16—Designates the metal or plastic rod

18—Shows the tapered hole which is narrower towards the flatter part of the nameplate and wider where the stake is inserted into the tapered hole.

### DETAILED DESCRIPTION OF THE INVENTION

While this invention may be embodied in many different forms, there are shown in the drawings and described in detail herein specific preferred embodiments of the invention. The present disclosure is an exemplification of the principles of the invention and is not intended to limit the invention to the particular embodiments illustrated.

There are two separate parts to the innovative garden marker designs. One part is a stake made of metal or plastic. The second part is a plastic nameplate that is designed in a new, innovative way. As gardeners would prefer to have two sides of a marker to add adhesive backed labels or written text to, or additional nameplates such as engraved nameplates, attaching the metal garden stake from a side, and preferably the bottom of the name plate is important. This new design makes that easy and functional.

The nameplates are designed so that much of it has a surface on one and preferably two sides that is significantly flat in the area the information will be added. But, the nameplate's surface doesn't have to be flat—it could be a variety of shapes included rounded, round, curved, etc—or portions of it could different. A curved surface would allow for a wide viewing angle from the sides of the nameplate. What is needed is an area to write with pen or paint pens, printed adhesive labels or to adhere engraved nameplates with tape or double sided foam stuck to both the garden marker's nameplate and the additional nameplate adhered.

The shape of the circumference of this flatter area that holds information can be rectangular, square, round, oval or other shapes.

The surface of the nameplate itself could have a texture on it to allow for adhesives, ink or paint markers to have extra surface area to stick to. And, this textured surface may also provide peaks and valleys to allow ink or adhesive to get into the bottom area to be protected from being rubbed off when something rubs on the top of the textured area.

To save money and materials during manufacturing, the part of the nameplate that will have information on it is designed to be thin yet strong enough to be durable. Of course, the less plastic used, the less expensive it is to manufacture. In addition, thicker plastic may slow down the injection molding process as the plastic takes longer to cool when thicker. During injection molding, drafts are used to allow the plastic to be ejected easily after molding.

The generally and substantially flatter nameplate area has a plastic area that extends down from the area where information can be added that referred to herein as the “connecting portion.” This connecting portion area is generally of greater diameter than the “flat part” of the name plate as it needs to connect a metal or plastic rod serving as the garden marker's stake, which is generally thicker in diameter that the flatter part of the nameplate.

This “connecting portion” is designed so that there is a tapered opening on the side of it but is still solidly attached to the main nameplate portion. One common design would be a rectangle looking nameplate with a nipple looking portion that serves as the “connecting portion” that is thicker than the flatter area of nameplate and has a tapered hole inside of it to enclose on three sides a metal or plastic rod and also serve to pinch the rod to hold it more securely. This connecting portion built in to the nameplate is where a tapered hole would be located that would also allow the rod to be inserted to different depths in the tapered hole for different levels of tightness.

The nameplate could be designed so that the “connecting portion” extension would not exist but the stake would be attached directly under the name plate via a tapered hole that goes into the name plate—minus what looks similar to a nipple as explained above. The disadvantage of that design is it would add thickness to the nameplate to accommodate the often larger size thickness of the stake, which would increase the amount of plastic used and thus the cost and also slow the manufacturing process as thicker plastic needs to cool longer during injection molding.

Because of the innovative tapered hole, the metal or plastic stake can be pushed in to the hole in the “connecting portion” until the stake is thicker than the diameter of the tapered hole and it will thus encounter resistance. As more pressure is exerted by pushing the stake further into the tapered hole of the “connecting portion,” the plastic will or may expand some, creating a tighter grip on the rod, or the stake might scratch into the plastic inside the hole as the rod is inserted with additional force and thus the tapered hole forms a tighter grip on the stake. The gardener can also control how easy the stake will come off the nameplate by how much pressure is exerted to place the stake in the tapered portion of the “connecting portion.” If a gardener wanted to make the stake and nameplate more permanent, some adhesive could be placed in the tapered hole that would help the stake and plastic name plate to stay together even more.

Most rods when examined closely are not perfectly round. In the case of metal rods, the thickness of the rod can vary caused by the extrusion process in which a metal rod is formed. Thus, the stakes manufacturing tolerances must be considered when designing the dimensions of the tapered hole. Obviously, if the tapered hole is designed too narrow and the rod is at the outer range of its manufacturing tolerance, problems could arise.

The steel rod is generally made using an extrusion process and sold in wound, long continuous coils. These coils need to be straightened using traditional industry methods in the wire forming industry before or during manufacture. Thus, to create the desired length of the stake, the continuous wound roll needs to be straightened and then cut to the length desired via something like scissoring, cutting or snapping during its manufacturing process. This process can create a slight burr on at least one side of the rod which will cause it to not be as round as might be desired. It has been found that it is possible that the two ends of a cut rod might have different sizes and type of burrs on them, and that one type of burr might fit into a hole better or worse than the other end of the rod.

These burrs on the end of the rod also need to be considered in the design process to make sure that the thickness of the rod where the burr is will still slip inside the beginning portion of the plastic tapered hole easily when attempted by the gardener. The burr can create another problem. It can be sharp and when inserted further and further into the tapered hole, it can scratch into the side of the plastic hole, and thus cause the plastic to stretch and grip less than if it were not scratched by the rod.

Another reason a tapered hole or opening is important is because the stake and the plastic name plate “connecting portion” and the burr will have some type of manufacturing tolerances that might vary from part to part, production run to production run, and raw material run to raw material run. Thus, having a tapered hole allows for these manufacturing variances in the stake and the size of the tapered plastic hole to be less of an issue. There is still room for manufacturing tolerances via the tapered hole so that fit does not need to be as precise—the tapered hole offsets that.

The tapered opening connecting to a somewhere near round rod with or without a burr on the end of it, can create a fairly tight fit. To create an even tighter fit, the end of the metal or plastic rod must be formed so that it is not as round as the plastic nameplate and there becomes more of an interference between the otherwise smooth metal rod and the plastic tapered hole. This will help eliminate the nameplate from spinning around the rounder rod or be pulled off easily when pressure is exerted to pull the rod out of the hole by pulling on the rod in the opposite direction in which it was inserted. Both types of pressure on the connecting portion can be exerted in various situations as when the garden marker is being handled by a gardener or when pets, freeze thaw, and other common forces in the garden exert spin or pull pressures on the connecting portion in someone's garden.

To prevent the rod that is inserted into the tapered hole from dislodging from the tapered hole easily, there is another unique design feature built into this invention, herein called a fin. This fin design feature helps prevent the nameplate from spinning around the rod and from being pulled off easily. The design feature creates interference or resistance. And, note there are different ways the fin or interference might be created that are functionally equivalents to my design and not needed to be explained herein.

Various plastics have many properties. Plastics can be scratched, they expand and contract with differences in temperature, and they can bend and stretch and can come back to its original shape or close to it—meaning it has some elastic qualities. It is also known plastic can flow or creep over time, meaning its shape and properties can change when stressed. It has something to do with the molecules moving.

To make the rod fit tighter in the tapered hole, through a process that might be called swaging, coining or stamping, so that garden marker will not spin or be pulled apart easily, the rod's cylinder metal shape is deformed to create more interference when placed inside the tapered hole in a way we herein call a “fin.” The metal rod is most often deformed by hitting, compressing or pinching (exerting force) on the metal rod, so that the hard steel rod which is the stake changes the shape of a portion of the rod that has been hit by metal punches or the like. Various types of shapes on the rod can be created to make the rod less round and thus create a stronger interference fit between the otherwise cylindrical shaped rod and the plastic tapered hole in the nameplate.
a) Compressing (hitting) the metal rod on one or two sides will often cause a deformation of the metal because the metal will be displaced and bulge out and thus become less round.
b) Hitting the metal rod from one or both sides so that the metal rod changes shape can be done parallel to the rod with steel tools made from strong often hardened steel having ridges that are parallel to the length of the rod.
c) The rod can be knurled to create peaks and valleys so that when inserted properly in the tapered hole, will cause the plastic to resist spinning on what would otherwise be a smooth cylinder rod.
d) Knick one or more sides of the metal so that the metal bulges out and creates what is herein called a “fin.” This is likely the most desirable.
   The “fin” design is beneficial for many reasons:
1) The fin can be made to protrude in different locations on the rod (the garden marker's stake). In the case of this design, we have made the fin away from the beginning edge of the rounded rod that is first inserted into the tapered hole. Having the fin away from the leading edge will make the rod easier to locate into the tapered hole because the thickness of the rounder rod (actually more oval due to the burr creating by cutting the rod from the coil) is less than the thickness at the inside dimension of the outside opening of the tapered hole.
2) By rounding the front edge of the fin it will make the plastic stretch around it more gradually than if the fin was more of a rectangular edge. This may allow the plastic to stretch around the fin which is more desirable than if it were to cut into the plastic with a more rectangular fin.
3) By rounding the back edge of the fin, the nameplate can be removed more easily if the gardener wants to remove the nameplate from the stake versus tearing or cutting the plastic.

It is important to note that the fin will cause the plastic to stretch and may even cut into the plastic in the inside of the tapered hole. It is also important to note that once the stake is inserted in the tapered plastic hole, the plastic might creep or flow so that the plastic tightens its grip around the fin. Thus, having the fin protrusion provides a shape that the plastic can anchor on to more easily as it flows or creeps around the fin over time, thus making the fit between the rod and the tapered hole, i.e. the plastic nameplate, the better.

It is also important to note that the tapered hole could also be designed to have a slit or slits like a groove in the side of the tapered hole which would allow the fins to slide into the tapered hole slightly easier. These slits could also be tapered to allow for a track or groove for the fin to travel on as it is pushed in the tapered hole but also tighten its grip on the stake or rod.

Note: all dimensions to follow are not the only dimensions that will make the garden marker functional.

FIG. 1 shows the basic garden marker's look when the two components, the nameplate 10 (the flatter rectangular portion 36 can be 0.082 inches (0.2083 centimeter) thick) and the metal or plastic rod 16 (made from 10 gauge 0.135 inch (0.3429 centimeter) diameter T304 grade stainless with the two fabricated fins 14 each protruding from the round rod approximately 0.014″ (0.3555 mm), the fin is hammered to approximately 0.015″ thick (0.3809 mm) and the fin's length is 0.10″ (2.54 mm) long when measuring the later parallel to the rod built into the rod 16 has been inserted inside of the tapered hole 18 that is inside the connecting portion nipple extending out the bottom of the nameplate 10 and shows where the rod and nameplate are connected in a unique way described herein. The rod 16 has an upper end 17 that is inserted into the tapered opening 18 of the nameplate 10 and a lower end 19 that is inserted into the earth.

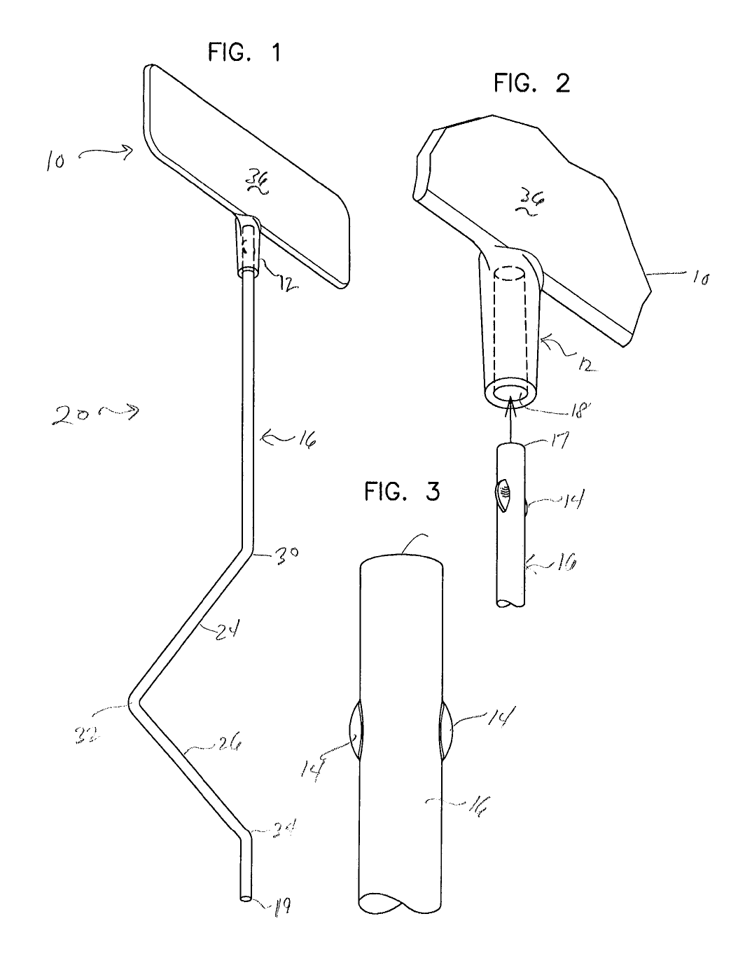

FIG. 2 shows a more close-up, detailed view of the nameplate 10 that has a connecting portion 12 (looks like a nipple) extending approximately 0.75 inches (approximately 1.905 centimeters) from the rectangular portion of the nameplate. This extending nipple has within it a tapered hole or opening 18 that is 0.68 inches (1.727 centimeters) in length. At 0.308 inch (0.7823 centimeter) into the tapered hole from the opening of the hole the width of the tapered hole is 0.135 inches (0.3429 centimeter) which is the same thickness as the standard 10 gauge stainless steel rod 16. The tapered hole 18 also allows for a manufacturing tolerance for the stainless steel rod of 0.001 inches (0.00254 centimeter) (illustrated by the broken line) and smaller tolerances for the injection molded plastic tapered hole. The tapered hole 18 allows the rod 16 (the stake) with the fabricated protruding fins) 14 to be inserted in the direction as noted by the arrow.

FIG. 3 shows a close up of the fabricated fins 14 that are protruding from the side of the otherwise cylinder shaped metal rod 16. These protrusions are formed by hitting the metal rod with lots of pressure by two round punches, two on each side of the round rod and also on the top and bottom of the rod on each side, in such a way as to pull, push, or pinch some of the metal away from the cylinder rod and form the protruding fin(s). The rounded design of the protruding fins serves to allow the rod to slide into the plastics tapered hole with less cutting and tearing. It allows the plastic to stretch easier and thus make a tighter fit between the stake and the plastic nameplate. However, other shapes for the protrusions may also work. This invention does not limit the shape of the protruding fins. One or more fins may be used.

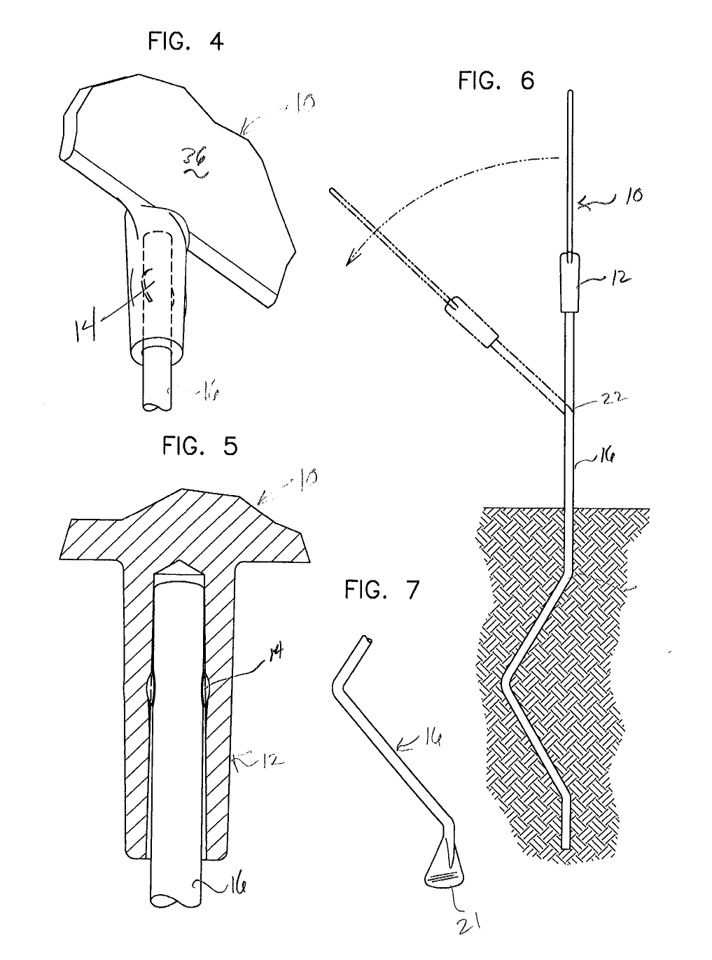

FIG. 4 shows the steel or plastic rod 16 with the protruding fin 14 after it has been inserted into the tapered hole 18. The protruding fin 14 on the rod 16 creates an interference with the tapered hole 18 and reduces the possibility of the nameplate from spinning on an otherwise round or oval rod. The protruding fins also create a surface almost like a hook that allows the plastic to flow or creep around over time, which also provides a tighter fit.

FIG. 5 shows a cut-away view of the connecting portion that looks like a nipple extending from the more rectangular (could be many shapes) nameplate area where information or adhesives may be added. The tapered hole 18 formed inside the surrounding plastic of the connecting portion nipple is shown. The fins 14 have been inserted inside of the tapered hole 18 and have either cut into the plastic or stretched the plastic creating an interference to prevent the nameplate from spinning on the round or oval cylinder shaped rod and from having the nameplate more easily removed from pulling on the nameplate 10 in a direction away from the open end of the tapered hole 18.

FIG. 6 shows a side profile of the garden marker 20 when the rod 16 and nameplate 10 are connected together via the connection portion 12. You can see that the area where the tapered hole 18 is located that connecting portion 12 has a greater thickness than the thickness of the plastic nameplate 10 where the information may be added or adhesives applied. You can also see the optional bend at point 22 in the rod 16 that is outside of the soil (designated by the thatched looking pattern) to create different viewing angle options for the gardener. In addition, you can see the double bend(s) 24, 26 created by bend points 30, 32 and 34 in the stake 16 that when inserted into the soil prevents spinning and enables anchoring into the soil better by creating an interference with the soil.

FIG. 7 shows an alternate stake 16 in which the lower end 19 may have a spade shape 21 which increases the surface area of the end which can also limit any tendency to rotate.

The rod for the stake portion is made from 10 gauge T304 stainless steel which is approximately 0.135 inches thick with a tolerance of +−0.001 inches The steel is wound in a roll as is common in the trade.

The plastic nameplate may be formed from a plastic, such as polypropylene. The plastic nameplate portion may be injection molded by a standard injection molding procedure and machine.

The stake can be manufactured in a one or two step process.

The one step process can be accomplished by using a Fourslide machine called the Nilson #S0, Nilson # 3F, Nilson # S5. The coil of metal material is inserted in to one end of the four slide machine, straightened, and then coined, forged, or punched which are similar words, to fabricate the protruding fin out of the other otherwise cylinder, round shaped stake metal rod which is being made into the garden marker's stake. At the same time, the continuous wound metal rod is cut with a scissor type action by the machine to the size of the stake desired. A different size hardened tool is used for the various length stakes. The tooling is essentially a male, female mold with a punches forming on a core pin, and then a male punch forming on the core pin and female punch.

The stake can also be manufactured in a two-step process. This can be accomplished by using a 2-Axis CNC Wire Forming machine and a hydraulic punch press. The wound metal stock is inserted into the CNC Wire forming machine which can be programmed via something like a computer so the machine straightens the metal and then bends the steel to create the double anchoring bend and viewing angle to the angles desired, and then cuts the rod to the desired length garden stake. One end of the steel rod stake may have a larger burr on it than the other, so care should be taken to determine which end of the garden stake to fabricate the protruding fin on. If the larger burr is placed in the tapered hole, it can cut into the plastic and cause the plastic to lose some of its grips on the steel.

The protruding fins may be fabricated by placing by hand one stake rod at a time into the middle of two separate strong hardened steel metal dies. Each die holds round punches securely. There is a groove made in the die(s) where the rod is held securely in place. The hydraulic press holding the two dies and round punches exerts pressure to hammer the two round punches from the top and bottom of each side of the rod and into a portion of the steel rod, in a sense pinching away some of the metal from the rod's cylinder and pushing it to a great width than that of the original rod. This hammering action causes the punches to pinch the cylinder round metal rod stock to create the metal fins to develop because a portion of the metal is pushed away from the more cylinder rod stock to form the fins. The total thickness of the fins are about 0.163 inches which is thicker than the width of the tapered hole thereby creating significant interference between the otherwise round metal rod stake and the tapered plastic hole located in the connecting portion of the plastic nameplate.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

This completes the description of the preferred and alternate embodiments of the invention. Those skilled in the art may recognize other equivalents to the specific embodiment described herein which equivalents are intended to be encompassed by the claims attached hereto.

1. A garden marker comprising:
a) a name plate portion including at least one relatively flat region onto which a label or writing may be added, said name plate including a connecting portion for connection to a stake, said connecting portion including a tapered opening into which a stake may be inserted; and
b) a stake having an upper and a lower end, said upper end including at least one fin member adjacent said upper end and spaced from said upper end such that a fin may enter said tapered opening of said connecting portion to improve an interference fit when said stake is connected to said connecting portion.

2. The garden marker of claim 1 wherein said lower end of said stake includes at least three intermediate bends from said upper end to form a bent portion such that when said lower end is inserted into earth that a bent portion is within the earth to limit spinning of said garden marker once so positioned.

3. The garden marker of claim 2 wherein said name plate portion is formed of plastic and said stake is a metal rod such that when said upper end is inserted into said tapered portion that an interference fit is made and said fins may cut into said connecting portion to make a more secure engagement.

4. The garden marker of claim 3 further including an additional bend toward the upper end such that the name plate is presented at a different angle from the remainder of said stake.

5. The garden marker of claim 1 wherein said name plate portion has two opposing sides with a relatively flat region on each side such that a label or writing may be added to one or both sides.

6. A garden marker comprising:
a) a name plate portion including at least one relatively flat region onto which a label or writing may be added, said name plate including a connecting portion for connection to a stake, said connecting portion including a tapered opening into which a stake may be inserted;
b) a stake having an upper and a lower end, said stake having at least three intermediate bends spaced from said upper end such that when said lower end is inserted into earth that a bent portion is within the earth to limit spinning of said garden marker once so positioned.

7. The garden marker of claim 6 wherein the lower end of said stake has an enlarged spade shape to decrease any tendency for the garden marker to rotate while secured in the earth.
